(19) United States
(12) Patent Application Publication
(10) Pub. No.: US 2023/0061935 A1
(43) Pub. Date: Mar. 2, 2023

(54) SYSTEM AND METHOD FOR PROVIDING AUGMENTED VIRTUALITY

(71) Applicant: Authenitck B.V., Amsterdam (NL)

(72) Inventors: Guillermo Blanco Benedicto, Madrid (ES); Elad Elyahu Gilo, Milan (IT); Stephen Alexander Stamm, Los Angeles, CA (US)

(21) Appl. No.: 17/790,547

(22) PCT Filed: Oct. 14, 2020
(86) PCT No.: PCT/IB2020/000857

§ 371 Date: Jul. 1, 2022

Related U.S. Application Data
(60) Provisional application No. 62/956,494, filed on Jan. 2, 2020.

(51) Int. Cl. G06T 19/00; G06T 5/50; G06T 7/13; G06V 10/60; G06V 10/74

(52) U.S. Cl. CPC G06T 19/006; G06T 5/50; G06T 7/13; G06V 10/60; G06V 10/761; G06T 2207/10024; G06T 2207/10028; G06T 2207/20221; G06T 2207/30196

(57) ABSTRACT

A system and method for providing an augmented virtuality solution. A real environment video frame of a human and background is captured. The human is removed from the real environment frame using an RGBA array, a depth array, and a stencil array and composited onto a virtual environment frame using occlusion depth array and refined depth mask array.

### TECHNOLOGICAL FIELD

This subject matter disclosed herein relates to providing an augmented virtuality solution for performing real-time capture of real environment media (e.g., video, images, etc.), performing occlusion on that real environment video, and compositing the occluded video into virtual content.

### BACKGROUND

Augmented Virtuality (AV) is a term used to describe the situation where a virtual environment (or the “virtual world”) (e.g., a background depicting outer space with a plurality of fictional outer space aircrafts engaged in battle and firing weapons) is augmented by means of the real environment (or the “real world”) (e.g., a human actor pretending to be part of the outer space battle). Conversely, Augmented Reality (AR), refers to all cases in which the display of an environment is augmented by means of virtual (computer graphic) objects.

Conventionally, using this example, to provide AV, a human actor would be filmed in front of a green screen in a green screen room which requires hardware and larger camera positional-tracking systems. Later, occlusion and composition processes would be performed using the video filmed in front of the green screen to provide a composite AV video showing the human actor in the virtual environment. The need for a green screen and the associated green screen hardware greatly increases the expense of providing AV. In addition, the need to composite the video later after filming (i.e., not in real time) delays the determination of whether the film is suitable for use with the virtual environment or needs to be re-filmed.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A system and method for providing an augmented virtuality solution by performing real-time capture of real environment media (e.g., video, images, etc.), performing occlusion on that real environment video, and compositing the occluded video into virtual content is disclosed. This AV solution can provide the impression that a human is being filmed at a location different than their real environment.

A system and method for providing an augmented virtuality solution is disclosed. A real environment video frame of a human and background is captured. The human is removed from the real environment frame using an RGBA array, a depth array, and a stencil array and composited onto a virtual environment frame using occlusion depth array and refined depth mask array.

In one embodiment, a mobile device captures high resolution real-time media of, e.g., a human on video that is cut-out and placed into virtual environments (e.g., a three-dimensional (3D) environment and two-dimensional (2D) media such as photo or video) enabling a mobile device user to detect himself or others from a video of the real environment, remove himself or others from the video of the real environment, and superimpose the human(s) into a virtual environment without the need for a green screen. Using depth and stencil texture information for each pixel of each frame provided by the camera(s) on the mobile device, a human mask can be separated from the real environment by subtracting the human from the real environment background in a frame, and, in real-time, composited on top of the frame of the virtual environment captured by the virtual camera that is locally mapped to the real environment. Before blending the pixels of the human from the real environment frame into the virtual environment, the lighting of human can be adjusted based on the luminosity of the virtual environment. This composite frame is recorded, stored in a buffer, and output to video once recording is complete.

A non-limiting list of potential fields of use for this AV solution include mobile device applications (commonly referred to as “apps”), social media, film making (including multi-actor film making whereby two different people can be filmed in two separate environments, at the same time, and be placed, in real-time, within the same shared virtual environment), location scouting for films, live reporting of current events using relevant environments (e.g. weather reporting), video blogging, music videos, video conferencing, law enforcement (e.g., placing a suspect within a virtual environment to help with memory recall, instead of a classic line up), retail sales (e.g., where customers could view themselves in a wall mirror that shows them with a virtual backdrop), etc.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Furthermore, the drawings may contain text or captions that may explain certain embodiments of the present disclosure. This text is included for illustrative, non-limiting, explanatory purposes of certain embodiments detailed in the present disclosure. Thus, for further understanding of the nature and objects of the invention, references can be made to the following detailed description, read in connection with the drawings in which:

FIG. 1 illustrates an exemplary system for providing an augmented virtuality solution on a mobile device;

FIG. 2A illustrates an exemplary real environment RGBA texture;

FIG. 2B illustrates an exemplary real environment depth texture based upon the real environment RGBA texture shown in FIG. 2A;

FIG. 2C illustrates an exemplary real environment stencil texture based upon the real environment RGBA texture shown in FIG. 2A;

FIG. 3A illustrates an exemplary virtual environment RGBA texture;

FIG. 3B illustrates an exemplary virtual environment depth texture based upon the virtual environment RGBA texture shown in FIG. 3A;

FIG. 4 illustrates an exemplary combined occlusion depth texture;

FIG. 5A illustrates an exemplary refined depth mask after multiplying the combined occlusion depth texture of FIG. 4 with the exemplary real environment stencil texture of FIG. 2C;

FIG. 5B is an illustration of the different pixel values of the exemplary refined depth mask of FIG. 5A;

FIG. 6 illustrates the adjustment of the luminosity of the exemplary real environment RGBA texture of FIG. 2A based on the luminosity of the exemplary virtual environment RGBA texture of FIG. 3A;

FIG. 7 illustrates an exemplary composite frame superimposing the real environment of FIG. 2A on the virtual environment of FIG. 3A using the refined depth mask shown in FIGS. 5A & 5B;

FIG. 8 illustrates another exemplary real environment RGBA texture;

FIG. 9A illustrates an exemplary composite frame superimposing the occluded real environment of FIG. 8 on a first exemplary virtual environment; and

FIG. 9B illustrates an exemplary composite frame superimposing the occluded real environment of FIG. 8 on a second exemplary virtual environment

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein. “a” and “an” each generally denotes “at least one.” but does not exclude a plurality unless the contextual use dictates otherwise. When used herein to join a list of items, “or” denotes “at least one of the items.” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a real-time capture solution for performing human occlusion and composition into localized 3D virtual content, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, and at least one network device. Examples of the one or more client devices and/or the server computer may include, a smartphone, a desktop computer, a laptop computer, a tablet computer, a personal digital assistant, a portable electronic device, a wearable computer, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. iOS, Android, Windows. Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

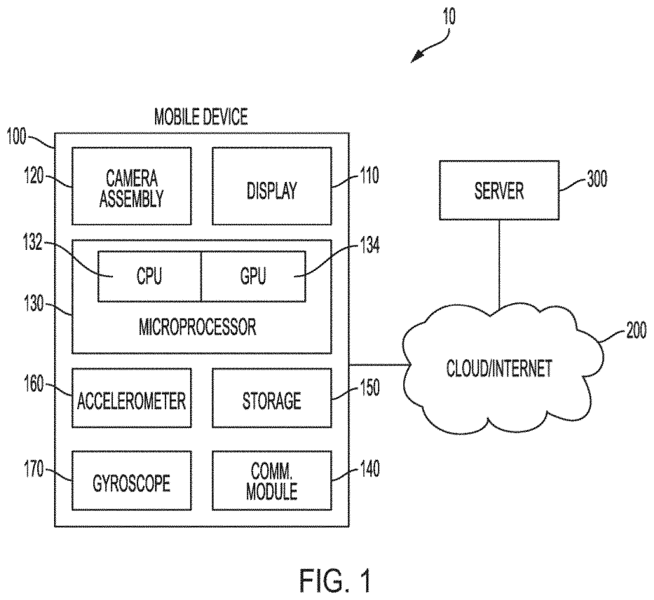

FIG. 1 illustrates an exemplary system 10 for providing an augmented virtuality solution on a mobile device 100. It will be understood that while the exemplary embodiment includes a mobile device (or client) 100 such as a smartphone (e.g., Apple iPhone, Samsung Galaxy, etc.), the inventive system and method can be employed by other electronic devices. The exemplary mobile device can include a display 110 with a certain number of pixels determining the resolution of the display 110 (e.g., 1280×720 (Standard HD), 1920×1080 Array (Full HD), 3840×1600 Array (4K), etc.) The mobile device can also include a camera assembly 120 for obtaining, e.g., RGB information (RGB texture) of video (including images) of the real environment as well as depth information about the objects in the real environment. For example, in one embodiment, one or more cameras 120 can be employed to obtain RGB information of the real environment being captured in real time. These cameras would typically be a higher resolution camera.

In one embodiment, one or more cameras 120 can be employed to obtain the depth information of the objects in the real environment being captured in real time. These cameras 120 would typically be a lower resolution camera. In one embodiment, a stereo solution is employed for determining depth in the real environment utilizing two cameras with a small distance between them. The disparity between the cameras creates per-pixel depth estimation in the scene of the real environment. The resolution of this depth information (or depth texture) is generally much lower than the native RGB camera of the mobile device due to the texture being generated by common data points between the two cameras. In other embodiments, models or algorithms may be deployed that can supersample textures, thus generating a higher resolution on the provided depth texture.

In another embodiment, the mobile device may incorporate a dedicated depth sensor that utilizes time of flight (ToF) to determine the depth of an object in the scene of the real environment. For example, a mobile device may utilize an infrared light by emitting the signal, and determining how far away the object is based on how long it takes for the light to return to the camera.

In yet another embodiment, the depth of an object in the scene of the real environment using a software-based solution, algorithm, or machine learning model that generates the scene depth understanding using RGB as the only input. In still another embodiment, the depth of an object in the scene of the real environment is determined using a software-based solution, algorithm, or machine learning model that generates the stencil array (cutting a person out).

The exemplary mobile device shown in FIG. 1 may also include a microprocessor 130 or other chip processor. In one embodiment, the microprocessor includes a computer processing unit (CPU) 132 for performing background computer processes on the mobile device and a graphics processor unit (GPU) 134 for handling the graphics and display on the mobile device. In one embodiment, the GPU 134 includes a shader, which can be software code run on the GPU receiving texture inputs of frames and performing algorithms on those frames on a per-pixel basis

The exemplary mobile device can also include a communications module 140 (e.g., a transmitter and receiver) to allow the mobile device 100 to communicate with other devices, such as over a network 200 in a distributed computing environment, for example, the Cloud or the Internet. In one embodiment, the communications module 140 is a client-server communications module enabling HLS Streaming and communications of client request calls to the server 300.

The exemplary mobile device can also include storage 150 in the form of volatile memory (Random Access Memory (RAM)) used for, e.g., temporary storage of frames when recording and non-volatile memory (Flash Memory) for storage of, e.g., video files or three-dimensional (3D) virtual environment files

The exemplary mobile device can also include an accelerometer 160 for determining the orientation of the mobile device 100 based on non-gravitational acceleration, and a gyroscope 170 for determining the orientation of the mobile device 100 based on gravity.

In one embodiment, the system and method for provide an augmented virtuality solution on a mobile device is provided by a mobile device application (commonly referred to as an “app”) installed on the mobile device. In another embodiment, the system and method is run on a remote system where the app is not installed on the mobile device and the image is streamed from the remote system to a receiving display.

In the exemplary method, the camera assembly of the mobile device is employed to perform real-time video capture of the real environment. In one embodiment, the mobile device uses native mobile device screen capture media frameworks to perform video transcoding of the app screen, based on user input. In one embodiment, the app employs the ReplayKit media framework to record videos and store on the mobile device storage. Other alternatives to using ReplayKit include GStreamer and FFmpeg media streaming frameworks. In one embodiment, encoding is done with the H.264 codec, but this may vary depending on the mobile device. Real-time capture can take place using device encoding, cloud encoding, streaming, or any other suitable method.

In another embodiment, rather than use screen capture, the method and system could also employ alternate media pipeline frameworks that do not perform screen capture, but instead write the final video to a frame buffer, which displays the final result, only including the video component instead of the screen (which could include the user interface (UI), notification pop-ups, etc.).

In the exemplary method, the 3D virtual environments can be stored on a centralized content database (e.g., a server or cloud database) in a descrialized format (including common or standard file formats such as .obj, .usd, .usdz, .tbx object file types. The exemplary system and method allows for the asynchronous loading of 3D virtual environments and swapping of 3D virtual environments scamlessly. These files containing the 3D virtual environments (or 3D virtual assets) can be stored in bundles and contain the geometry, texture, and lighting information required to produce an aesthetically pleasing virtual environment scene. These 3D virtual environments may either be requested/downloaded by the mobile device client as single instances or as a bundled package—multiple 3D virtual environments as part as a single download request. The 3D virtual environments can be requested by reading a text-based dictionary, and then using this information, the 3D data file can be retrieved off of the content delivery network (CDN). In that example, the app points to the dictionary, the dictionary points to the location of the 3D virtual environment, and the app downloads the 3D virtual environment.

In one embodiment, the entire 3D virtual environment is downloaded onto the mobile device as a 3D file. The 3D file can be streamed from the server or cloud database to the mobile device. The 3D file can be transferred as an entire file, or be broken into smaller pieces to stream lower detail versions only containing a fraction of the full 3D information.

In one exemplary data transfer method, the stored 3D virtual environments are serialized for network transfer. The 3D virtual environments are transferred as a compressed byte array. Client-server methods could utilize MPEG-DASH, HLS, Smooth Streaming, or HDS. Variations might also include peer-to-peer methods where 3D virtual environments are requested and transmitted between clients in as a shared network environment. In some embodiments, the server or cloud database stream the virtual environment frame by frame. In some embodiments, separate pieces of the virtual environment may be streamed separately (e.g., in a scene with a virtual castle, the landscape may be streamed in separately than the virtual castle object. While both are part of the same virtual environment, pieces of the environment may be streamed separately depending on the application. The 3D virtual environment database is independent of the shader timing, and is constrained by the network speed of the phone and the available bandwidth.

Then, the mobile device can de-serialize the 3D virtual environment and convert it back to 3D format understood by 3D engine (.obj, .usd, etc.) on the mobile device. The 3D virtual environment can be stored in a de-serialized form on the mobile device for future quick access in a local or personal cloud database. The virtual environment can get “cached” and stored in the internal device storage. The virtual environment also be accessed via RAM if the application has loaded in the virtual environment and it continues running.

In this example, the 3D virtual environment database can store a copy of the 3D virtual environment and send the serialized 3D virtual environment to be downloaded upon client request. Once the application has a stored copy of the 3D virtual environment, the view is rendered by the virtual camera in the engine (e.g., a real-time game engine). This view is rendered as a 2D texture with RGB data (with depth). This texture is used by the shader in the GPU to perform the image processing.

In some examples, the 3D virtual environment database is loaded in at the start of the application, and additional 3D virtual environments by user interaction, downloading additional content.

Variations of this loading may also include pagination. For example: a user downloads a 3D virtual environment, and the next 3D virtual environment might be the next step for the user to select. The application may preload a lower-quality version of the 3D virtual environment, so when the user selects it, the low quality model instantly renders on the application, and the higher-quality texture and geometry information gets rendered as it gets loaded in or streamed down if being accessed by the client-server. This occurs by deploying lower-resolution 3D files, prioritizing their downloading, and then downloading the full-resolution model so the user can interact with a low quality version before the ideal full-resolution 3D file finishes downloading and can load the 3D file (which generally contains much more information than other types of files, such as .txt or .doc)

The 3D virtual environment may or may not contain a skybox render. This can be imagined as the backdrop to a virtual scene that always gets rendered to the far back plane on a composition, then the rest of the virtual elements will render in front since they are closer to the virtual camera. For example, if the virtual environment was the moon, the skybox would be the stars in the background, where the virtual elements rendered in front would include the ground, rocks, etc.

In the exemplary method, the mobile device performs localization to match the real environment with the virtual environment. In one example, once the camera assembly of the mobile device begins to operate, it begins looking for feature points, and using this information the software will generate a 3D coordinate space that is based on the real environment, but is used to inform the 3D coordinate system that determines the location of the virtual environment and objects. Each app session, a new local coordinate system can be generated so the mobile device can understand the local space. Another embodiment might save/store the data that informs the local coordinate system and load the same info when reopening the application, as opposed to generating new data each time it is opened. While each app session can generate a new local coordinate system, there is also the possibility of storing the local coordinate system on the device to be pre-loaded later (the data could be saved as a ‘room’ and loaded by the user, so the app doesn't need to create a new local coordinate system each time it starts up.) The session generates feature points that anchor the virtual session with the same position and rotation as the real environment. The feature points can form a set of generated 3D digital anchors that get attached to the real environment. These anchors can be given a position vector in 3D space based on differences in pixels between frames. The unified set of these 3D position vectors determine the 3D coordinate system of the virtual content, based on the real environment camera information. So when the user walks through the real environment, the 3D anchor can move with the user, informing the virtual environment how to transform the virtual content.

In one embodiment, the app will have a collection of these feature points. More points means the renderings of the virtual environment are more stable and localized with the real environment. The feature points to determine this correspondence are determined using a process called visual-inertial odometry, utilizing motion sensing in mobile devices along with computer vision analysis to pick out the feature points. Then the 3D knowledge is constructed by determining the differences between these features across video frames.

The application can utilize a combination of feature point detection with planar tracking. The feature points pulled from the ground can be easily grouped based on their planarity with the surface. Using this with the motion sensing hardware of the mobile device (accelerometer and gyroscope), an experience can feel more immersive by being aligned in both the real environment and the virtual environment and matching the ground plane between both the real and virtual environments.

This localization can be used to provide the location of the virtual camera in the 3D coordinate space of virtual environment. The viewpoint of the virtual camera can be based on the position and orientation of the mobile device or the camera assembly of the mobile device. For example, if a user places the camera assembly at a low location (near his waist) but facing up, the virtual environment might show the sky. But if the user places the camera assembly at a higher location (above his head) but facing down, the virtual environment might show the grass.

In one embodiment, the virtual camera and mobile device (real) camera can be 1 to 1. This means the coordinate system of the virtual camera and the coordinate system of the real camera are synced. 1 to 1 means when the device moves 1 meter in x direction, the virtual camera in the 3D engine (e.g., a real-time game engine) will also move 1 meter in the same direction. This also includes orientation, so as the device camera might look to the left, the virtual camera is synced and will also look to the left.

In another embodiment, the virtual camera and real device camera are not 1 to 1 (i.e., one meter walking in the real world may be equal to a kilometer in a virtual world). The difference would be applying a scale factor multiplication to the original scale of the virtual 3D file.

Feature points determined using the real-camera give a coordinate system to the virtual camera, which in turn renders the virtual content from the appropriate angle. The correspondence between the real environment coordinate system and the virtual coordinate system create a more immersive experience. Using the constructed 3D coordinate system from the real environment camera, when the device alters position and rotation, this information per-frame drives the virtual camera position and rotation at the same rate.

When the camera assembly of the mobile device is employed to perform real-time video capture of the real environment, the frame rate for the video capture of the real environment can be, e.g., 30 frames/second or 60 frames/second, or any other common or uncommon framerate depending on the device camera (e.g., 24, 25, 29.997 frames/second). For each frame, the mobile device obtains RGBA (Red, Blue, Green, Alpha) information for each pixel of each frame, thereby rendering a 2D array of RGBA data (or 2D RGBA texture) for each real environment frame. Each pixel in the frame will have, e.g., an R value in the inclusive range between 0.0 and 1.0, a G value in the inclusive range between 0.0 and 1.0, and a B value in the inclusive range between 0.0 and 1.0. Variations may include differences in float value precision. For example, precision of the float value is usually 32, 24, or 16 bits based on the computer system, but this precision for calculating values throughout (anything 0.0 to 1.0) may vary, and may potentially include higher precision in future computing systems. The “A” stands for alpha channel or the 4th channel of the RGBA texture and includes the transparency value for the pixel which is typically 1.0 for no transparency (with 0.0 being for full transparency). As will be discussed, the alpha channel also includes depth information for the pixel.

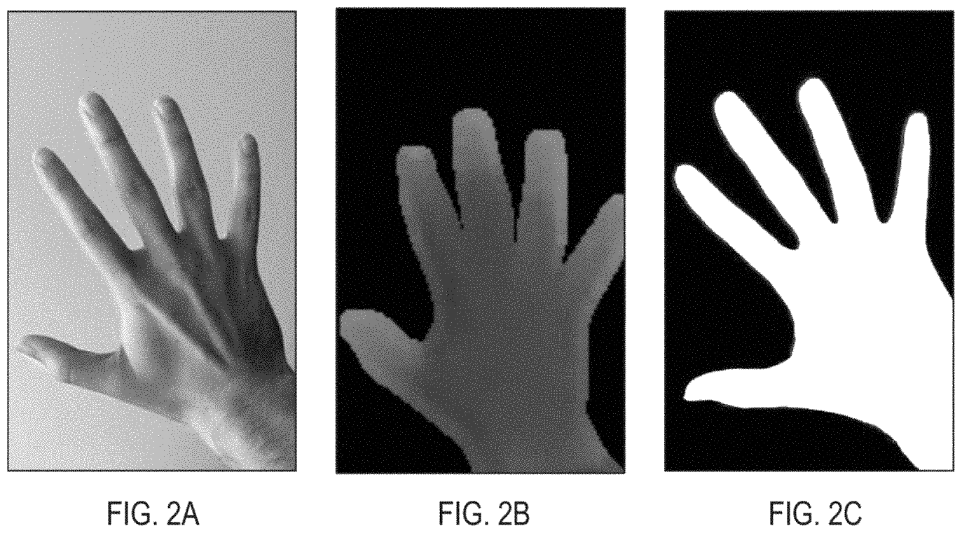

FIG. 2A illustrates an exemplary real environment RGBA texture. This is the standard video frame captured with the camera(s) of the mobile device. It records the real environment including people and their physical surroundings. As shown in FIG. 2A, a human hand and a background of a wall is captured in the real environment.

As discussed above in FIG. 1, one or more cameras of the mobile device (e.g., stereo cameras, device depth cameras) can be employed to obtain the depth information of the objects in the real environment being captured in real time. In another embodiment, motion vectors can be used to generate a 2D depth texture. Motion vectors are another 2D texture array that consists of a 2D vector at each pixel and is mainly used for estimation of frames. Using pixel color along with motion vectors can help predetermine the pixel colors of the next frame.

This depth information includes a depth value for each pixel of each frame, thereby rendering a 2D array of depth data (or 2D depth texture) for each real environment frame. Each pixel in the frame will have a depth float value in the inclusive range between 0.0 and 1.0. The real environment depth texture is rendered alongside the color as an RGBA texture. The ‘alpha’ channel contains a float value in the inclusive range between 0.0 and 1.0 that will be used by the shader of the GPU as the real environment depth texture. The value 0.0 in the A of RGBA means the object is as close as possible to the camera. The value of 1.0 means the object is as far away as possible from the camera. Per-pixel depth is rendered as a 2D texture, an array of float values in the inclusive range between 0.0 and 1.0. It captures a frame of the depth information extracted from the real environment scene.

FIG. 2B illustrates an exemplary real environment depth texture based upon the real environment RGBA texture shown in FIG. 2A. In one embodiment, pixels that are closer to the camera are assigned lower depth values and shown darker, with a depth value of 0.0 shown in black representing an object as close as possible to the camera (near clipping plane). Pixels that are farther from the camera are assigned higher depth values and shown lighter, with a depth value of 1.0 shown in white representing an object as far as possible from the camera (far clipping plane). The darker pixels that are closer to the camera and lighter pixels that are farther from the camera are applied only between the near and far clipping planes. Using this exemplary convention, as can be seen in FIG. 2B, since the edge areas on the hand are farther away from the camera than the center of the hand, the pixels for the edges of the hand are shown lighter and have higher depth values (closer to 1.0) than the pixels for the center of the hand that are shown darker and have lower depth values (closer to 0.0). Also, since the thumb is farther away from the camera than the other fingers, its pixels are rendered lighter (with higher depth values) than the pixels for the other fingers.

However, if the camera cannot detect any depth for a pixel because the object sits outside the near and far clipping planes, it will return a depth value of 0.0 (black) for that pixel as the background for the real environment depth texture. As shown in FIG. 2B, even though the wall background shown in FIG. 2A is farther away than the hand, the pixels showing the wall background are shown as black and assigned a depth value of 0.0 since the wall background falls outside the far clipping plane of the depth camera (out of range) and no data is determined at that pixel.

In addition to RGBA and depth 2D textures for each frame of the real environment, in one embodiment, the mobile device also renders a 2D stencil array (or texture) for each frame. Existing apps, including ARKit, can provide information on the location of people and AR content in a frame. In one embodiment, the stencil texture is generated via ARKit personSegmentationWithDepth and ARMatteGenerator.

ARKit can run on the CPU of the mobile device and receive as inputs the real environment 2D RGBA texture shown in FIG. 2A and the real environment 2D depth texture and create a real environment 2D stencil texture. Using methods from ARKit, a stencil texture is generated based on machine learning shape identification methods. This texture is updated each frame by the app session and consists of a 2D pixel array of 0.0 (pixel is not associated with a person) and 1.0 (pixel is associated with a person (“human detected”) values to determine which pixel is associated with the person. Stencil texture values in the inclusive range between 0.0 and 1.0 can be stored in a 2D array of float values, usually stored in the r, g, b, or a channel of an RGBA texture. In other embodiments, textures other than RGBA textures can be used to utilize the stencil texture.

In another embodiment that does not use ARKit, a stencil texture is generated by using another type of machine learning shape identification method (e.g., semantic segmentation, instance segmentation, and alpha matting) to generate the depth texture.

FIG. 2C illustrates an exemplary real environment stencil texture based upon the real environment RGBA texture shown in FIG. 2A. The black pixels in the stencil texture represent real environment pixels that have a stencil value of 0.0 (pixel is not associated with the person) while the green pixels represent real environment pixels that have a stencil value of 1.0 (pixel is associated with a person (“human detected”)).

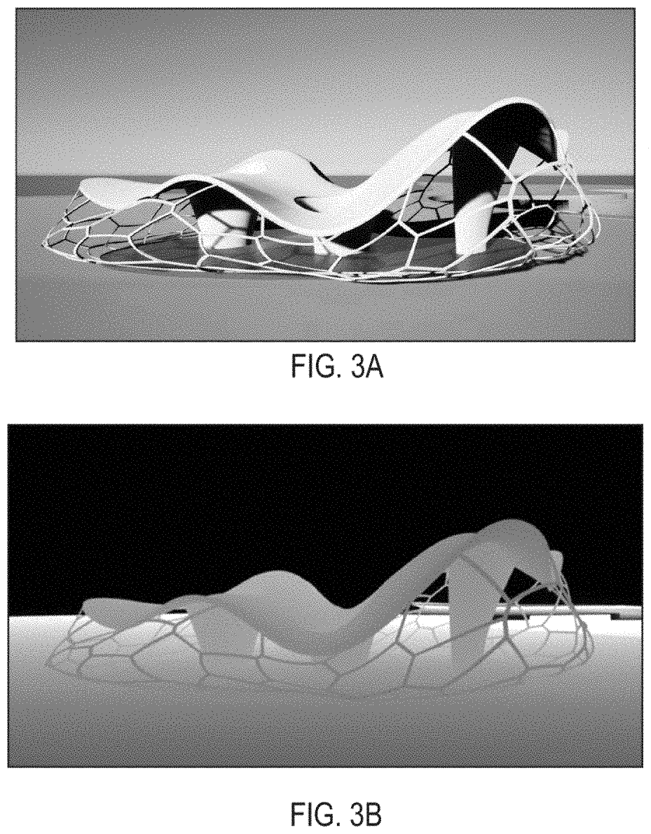

In addition to obtaining 2D RGBA information for the frames of the real environment, the mobile device also can obtain 2D RGBA information for the frames of the virtual environment and render a virtual environment. FIG. 3A illustrates an exemplary virtual environment RGBA texture. These virtual environment frames can be generated from 3D game engines or computer graphic (CG) rendered objects from the position of the virtual camera. This virtual camera has a transform consisting of position and rotation that is driven by the values of the virtual scene localization. Since both the real camera and the virtual camera are updating the texture data at the same frame rate, for each real environment frame captured by the mobile device camera assembly, the mobile device virtual camera performs an update to its transform at the same rate. On each tick of the loop in the game engine, the virtual camera can render the RGBA virtual environment texture only once thus making this step more optimized for the mobile device.

As was the case with the real environment, for each virtual environment frame, the mobile device obtains RGBA (Red, Blue, Green, Alpha) information for each pixel of each frame, thereby rendering a 2D array of RGBA data (or 2D RGBA texture) for each virtual environment frame. Each pixel in the frame will have, e.g., an R value in the inclusive range between 0.0 and 1.0, a G value in the inclusive range between 0.0 and 1.0, and a B value in the inclusive range between 0.0 and 1.0. The “A” stands for alpha channel or the 4th channel of the RGBA texture and includes the transparency value for the pixel which is typically 1.0 for no transparency (pixel is shown to the fullest extent) with 0.0 being for no transparency (pixel is not visible). As will be discussed, the alpha channel also includes depth information for the pixel. In other embodiments, the depth texture could be used as input in some other way. For example, instead of being optimized and placed into the ‘A’ channel of RGBA, the depth value could be its own independent 2D texture of float values in the inclusive range between 0.0 and 1.0.

As discussed above, the 3D virtual environment can be streamed to the mobile device. Just like the real camera can capture a frame of the real environment at a rate of 30 frames second or 60 frames/second, or any other common or uncommon framerate (e.g., 24, 25, 29.997 frames/second), the virtual camera can provide a frame of the virtual environment at the same frame rate. While the frame rate between the real environment camera and the virtual camera may vary, most commonly the two frame rates will be synced. The shader runs at the frame rate of the 3D game engine (e.g., 60 times per second), and is dependent on the speed of the processor on the mobile device. Mobile devices with more robust hardware may be able to run faster frame rates, and faster per-pixel calculations.

FIG. 3B illustrates an exemplary virtual environment depth texture based upon the virtual environment RGBA texture shown in FIG. 3A. As was the case with the exemplary real environment depth texture shown in FIG. 2B, pixels that are closer to the virtual camera are assigned lower depth values and shown darker, with a depth value of 0.0 shown in black representing an object as close as possible to the camera (near clipping plane). Pixels that are farther from the camera are assigned higher depth values and shown lighter, with a depth value of 1.0 shown in white representing an object as far as possible from the camera (far clipping plane). If the camera cannot detect any depth for a pixel because the object sits outside the near and far clipping planes, it will return a depth value of 0.0 (black) for that pixel as the background for the virtual environment depth texture.

Since the virtual camera has greater control over how it renders virtual content, this camera can render the depth information into the alpha channel of the RGBA texture for the virtual environment, along with the RGB pixel information to be used by the shader for the composition. Just like the real environment depth texture, the depth texture generated by the virtual camera is rendered as RGBA, where the ‘alpha’ channel contains the same inclusive range between 0.0 and 1.0 float value that indicates the depth of the virtual object from the virtual camera. The value 0.0 in the A of RGBA means the object is as close as possible to the camera and sits on the near clipping plane of the camera. The value of 1.0 means the object is as far away as possible from the camera and sits on the far clipping plane of the camera. The virtual RGB camera may generate textures of type depth, depth with normals, motion vector maps, or other types of methods that contain depth information in textures. Additional methods of determining depth for the virtual environment depth texture may include performing raycasting, raymarching or mytracing.

All of the real environment and virtual environment 2D texture inputs can pass through a shader, which is processing on the GPU on a per-pixel basis to perform occlusion and compositing as discussed below. Any of the textures may be encoded in a variety of ways. If frames are processed and then streamed from a server, the video may be may be encoded in H.264, HVEC, VP8, VP9, etc. Video is packaged as a bitstream so that the data may be sent over a network connection.

In the exemplary method, the mobile device performs an occlusion process to identify the particular pixels in the real environment frame that will be composited on the virtual environment frame. This occlusion process occurs on a per-pixel basis for each pixel in the real environment 2D RGBA texture and the virtual environment 2D RGBA texture. The shader can employ a step function on a pixel-by-pixel basis to identify the pixel that is closer to its camera between the real environment pixel and the virtual environment pixel.

The step function step(realWorldDepth, virtualDepth) can be employed to perform this comparison. The float value for the ‘A’ in real environment RGBA representing the depth for that pixel (inclusive range between 0.0 and 1.0) is equal to realWorldDepth. The float value for the ‘A’ in the virtual environment RGBA representing the depth for that pixel (inclusive range between 0.0 and 1.0) is equal to virtualDepth. A lower float value for the ‘A’ closer to 0.0 indicates closer to the camera and a higher float value for the ‘A’ closer to 1.0 indicates farther from the camera.

The step function step(realWorldDepth, virtualDepth) returns a discrete value of 0.0 or 1.0 by comparing two pixel values at the same 2D texture coordinate (u, v) (this can be thought of as (row, column)). If virtualDepth is greater than or equal to the realWorldDepth (this indicates that the virtual environment pixel is the same or farther away than the real environment pixel), the step function returns 1.0 and the closer real environment pixel will be rendered. If virtualDepth is less than the realWorldDepth (this indicates that the virtual environment pixel is closer than the real environment pixel), the step function returns 0.0 and the virtual environment pixel will be rendered. For example, if the real environment depth for a pixel is equal to 0.2, and the virtual environment depth for that same pixel is equal to 0.8 (i.e., the real environment pixel is closer than the virtual environment pixel), since virtualDepth is greater, the step function will return 1.0 and the real environment pixel will be rendered. On the other hand, if the virtual environment depth for a pixel is 0.1, and the real environment depth for that same pixel is 0.3 (i.e., the virtual environment pixel is closer than the real environment pixel), since virtualDepth is less than realWorldDepth, the step function will return 0.0 and the virtual environment pixel will be rendered. Therefore, the combined occlusion depth texture contains a 2D array of pixels with values of 1.0 and 0.0, with values of 1.0 indicating the pixels that will render as part of the real environment, and values of 0.0 indicate the pixels to be rendered as part of the virtual environment.

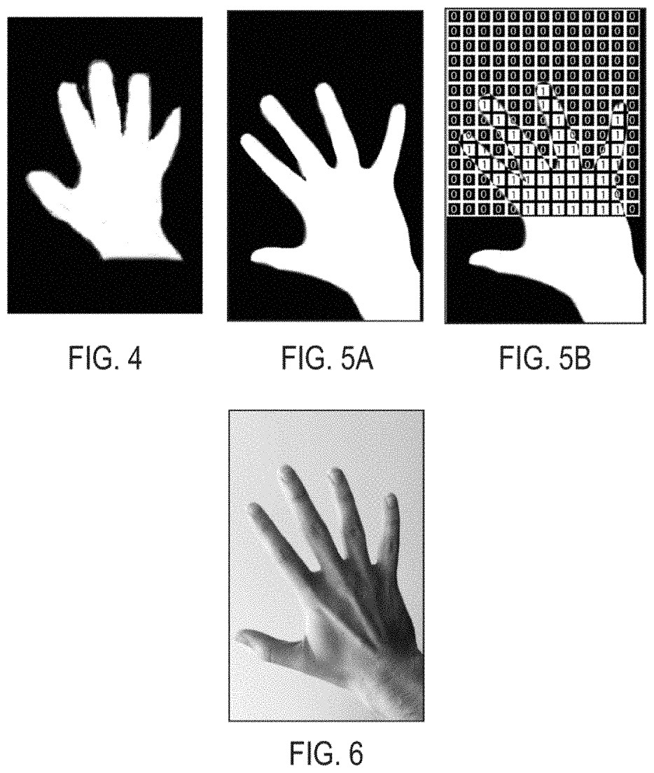

FIG. 4 illustrates an exemplary combined occlusion depth texture. The black pixels in the combined occlusion depth texture represent pixels with a value of 0.0 that will render as part of the virtual environment since the virtual environment pixel was closer than the real environment pixel. The white pixels in the combined occlusion depth texture represent pixels with a value of 1.0 that will render as part of the real environment since the real environment pixel was closer than the virtual environment pixel.

To generate combined occlusion depth texture, which is the result of the step function (0.0s for virtual environment pixel and 1.0s for real world environment pixel), the system and method must be able to address the pixels that have been assigned a depth value of 0.0 (realWorldDepth=0.0 or virtualDepth=0.0) since the camera could not detect any depth for the pixel because the object sits outside the near and far clipping planes. In one embodiment, prior to running the step function (step(realWorldDepth, virtualDepth)), the system checks to see if either pixel has been assigned a depth value of 0.0 (realWorldDepth=0.0 or virtualDepth=0.0). If either depth value is equal 0.0 as result of there being no depth data for that pixel, the virtual environment pixel should be rendered without the need for running the step function (i.e., the equivalent of the step function returning a 0.0 to indicate rendering of a closer virtual environment pixel). If the system determines that neither depth value is equal to 0.0 (e.g., values 0.01 to 1.00), the system performs the step function as described above.

In addition to determining which pixels between the real environment and the virtual environment are closer to their respective cameras and therefore can be part of the composite frame, the occlusion method also can determine which pixels in the real environment are associated with a person (“human detected”). As discussed above, the mobile device can obtain a 2D stencil texture for each real environment frame as shown in FIG. 2C. The black pixels in the stencil texture represent real environment pixels that have a stencil value of 0.0 (pixel is not associated with the person) while the white pixels represent real environment pixels that have a stencil value of 1.0 (pixel is associated with a person (“human detected”)).

In one embodiment, the combined occlusion depth texture illustrated in FIG. 4 that identifies which pixels between the real environment and the virtual environment are closer to their respective cameras (black pixel=0.0=virtual environment pixel closer; white pixel=1.0=real environment pixel closer) can be multiplied by the real environment 2D stencil texture for each real environment frame shown in FIG. 2C. In the multiplication of pixels, if either pixel has a value of 0.0 (i.e., combined occlusion depth texture=0.0 meaning the virtual environment pixel was closer, or the stencil texture=0.0 indicating that the pixel is not associated with a person), that pixel will have a value of 0.0 in the refined depth mask. So if a pixel has combined occlusion depth texture=1.0 meaning the real environment pixel was closer, but the stencil texture=0.0 indicating that the pixel is not associated with a person, that pixel have a value of 0.0 in the refined depth mask and will display a virtual environment pixel.

FIG. 5A illustrates an exemplary refined depth mask after multiplying the combined occlusion depth texture of FIG. 4 with the exemplary real environment stencil texture of FIG. 2C. FIG. 5B is an illustration of the different pixel values of the exemplary refined depth mask of FIG. 5A. Only if the both pixels have a value of 1.0 in the combined occlusion depth texture meaning the real environment pixel was closer, and in the stencil texture indicating that the pixel is associated with a person (“human detected”) will that pixel have a value of 1.0 in the refined depth mask.

In one embodiment, the combined occlusion depth texture illustrated in FIG. 4 is not separately rendered before being multiplied by the exemplary real environment stencil texture of FIG. 2C. Instead, the result of the step function step(realWorldDepth, virtualDepth) for a pixel that can be used to render the combined occlusion depth texture is multiplied by the real environment stencil texture value for that pixel in one line of code.

In other embodiments, this refined depth mask may also be created by only using the real environment RGBA texture (FIG. 2A), the virtual environment RGBA texture (3A), and the real environment stencil texture (FIG. 2C) without the combined occlusion depth texture (FIG. 4). Since this mask would not have any depth texture applied, occlusion of the real and virtual space would not function. However, this stencil texture may still create a cutout of the person that may be utilized in the mask compositing phase. The mask may or may not include occlusion information to make virtual object distance determinations.

In some embodiments (e.g., those that rely on hardware to infer depth data), additional steps can be taken to further enhance the refined depth mask. For example, a sample color can be used as input in the shader to help refine the mask generated by the depth data. As the generated depth texture is the image disparity between the two device cameras, the resolution of the depth texture will generally be lower than the RGB cameras. This lower resolution may create artifacts, or the chroma bleed effect, which are the unwanted color pixels of the subject's backdrop. Using the additional step of chroma keying can help refine the mask to aid in a more polished and accurate cutout of the person.

Edge detection may be used to identify the area of the chroma bleed effect and can be determined in a variety of methods, including user-defined methods. Edge detection algorithms such as the Sobel operator may be used in the shader to create an outline of the input mask. The average pixel value of this outline, composed of color values of pixels that inhabit this outline will give a rough determination of the color of the edge of the mask. This generated outline then can then be utilized in the shader to remove the pixels that contribute to the chroma bleed effect. The method of determining if the color pixel gets discarded, first a sample input color is sent into the shader. If the absolute value of the difference of this input color is smaller than a tolerance value, then this pixel should be discarded, as its color is similar enough to the input color. Other edge detection algorithms that may be used to refine the mask include Prewitt, Roberts. Laplacian of Gaussian, Canny, and approximate Canny. Variations of this chroma method may include testing pixel color in RGB YUV, and HSL/HSV color space. In another embodiment, chroma sampling methods may be selected by the user or employ chroma sampling of feature points on a planar surface (e.g., detect pixel color of wall).

In the exemplary method, before blending the pixels of the human from the real environment frame into the virtual environment, the lighting of human can be adjusted based on the luminosity of the virtual environment. Since the shader has a stored version of the virtual environment RGBA texture (FIG. 3A), the pixels per frame can be sampled to infer some lighting information and apply it to the real environment refined depth mask of the person. For example, for a darker virtual environment frame, the shader can sample this frame and determine the average luminosity of the pixels. This factor may then be applied to the pixels of the real environment so the person blends into the virtual environment more cleanly.

In one embodiment, a luminosity coefficient could be determined by measuring the pixels of the virtual environment frame. The shader can apply this coefficient to the RGB aspects of the real environment frame pixels.

For example, if a virtual scene environment frame pixel has an RGBA value of (0.3, 0.3, 0.3, 1.0), this indicates a darker scene since the color values are closer to 0.0. A luminosity coefficient could be determined based on these RGB values (e.g., coefficient=0.3). Assume that the corresponding real environment frame pixel is brighter and has an input RGBA value of (0.8, 0.8, 0.8, 1.0). The virtual environment luminosity coefficient could be applied to this real environment frame pixel by multiplying the RGB values of the real environment RGBA texture (i.e., not the depth or A value) by this virtual environment luminosity coefficient and then subtracting this result from the real environment RGB values. (0.8-0.3*0.8, 0.8-0.3*0.8, 0.8-0.3*0.8, 1.0). This would result in lower (darker) revised RGB values for the real environment of (0.56, 0.56, 0.56, 1.0), thus blending them more closely into a darker environment. FIG. 6 illustrates the adjustment of the luminosity of the exemplary real environment RGBA texture of FIG. 2A based on the luminosity of the exemplary virtual environment RGBA texture of FIG. 3A.

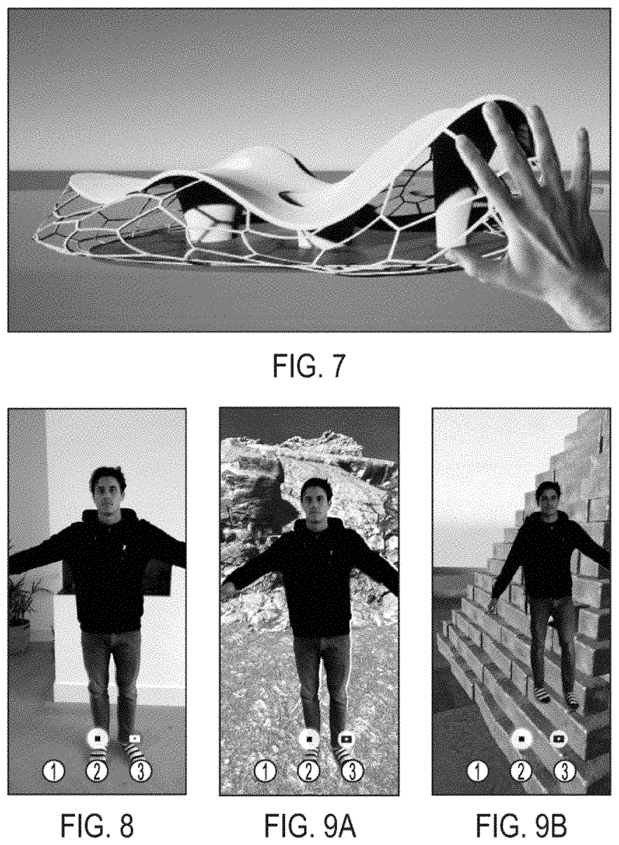

Once the occlusion process is completed and the refined depth mask shown in FIGS. 5A and 5B is determined, in the exemplary method, the real environment of FIG. 2A can be superimposed on the virtual environment of FIG. 3A using the refined depth mask shown in FIGS. 5A & 5B to form a composite frame. FIG. 7 illustrates an exemplary composite frame superimposing the real environment of FIG. 2A on the virtual environment of FIG. 3A using the refined depth mask shown in FIGS. 5A & 5B.

In forming this composite frame, if objects from the virtual environment are behind the person in the real environment (as might be the case with large real environments), the person cutout renders on top. But if a virtual object passes in front of the person (like a ball), this virtual object will render on top of the cutout. They share a renderable depth space.

In one embodiment, using linear interpolation, the real environment RGB texture and the virtual environment RGB texture are blended by a factor of the refined depth texture.

Once we reach this step the ‘A’ component of the RGBA texture of the real environment is set to 1.0 and the ‘A’ component of the RGBA texture of the virtual environment is also set to 1.0, so the final color value is not affected by the depth information utilized in the occlusion determination step, which his would cause some pixels to be partially transparent based on their value between 0.0 and 1.0.

The exemplary ‘interpolation’ function in shader (lerp(virtualRGBA, realWorldRGBA, depthMask) has several inputs (lerp(float4, float4, float)). By this function, where the values are 0.0 in for a pixel in the refined depth mask, the output color for that pixel in the composite frame will be derived from the virtualRGBA (since it's in the first argument). When the values are 1.0 for a pixel in the refined depth mask, the output color for that pixel in the composite frame will be derived from the real environment RGBA (since it's the second argument). This is the main determination to which color is output in the composite frame (if refined depth mask is 0.0 the virtual environment pixel is used and if the refined depth mask is 1.0, the real environment pixel is used).

) For example, assume that the virtual environment pixel RGBA is (0.8, 0.4, 0.2, 1.0) and the real environment pixel RGBA is (0.2, 0.3, 0.4, 1.0). When the refined depth mask is 0.0, the returned color is that of the virtual environment pixel RGBA (0.8, 0.4, 0.2, 1.0), but when the refined depth mask is a 1, the returned color is that of the real environment pixel RGBA (0.2, 0.3, 0.4, 1.0).

This color value is returned by the shader, containing a completed composite image with pixels from the real environment and the virtual environment, thus performing the process to composite the person into the virtual scene on the display or application. This returned color is the image that gets displayed, and is read by the real-time media capture framework. The person cutout that gets generated may be composited on top of 3D environments. But it may also be rendered on 2D assets such as images, video, sprites, and other 2D imagery.

Once the composite frame has been created and displayed in real-time, the frame can be stored in the video output buffer temporary storage of the mobile device (e.g., RAM) until the video is completed when it can be saved in flash memory if desired. The final pixels displayed on the mobile device display are the return values of the shader. The real-time media capture grabs this returned color as the texture used for the media encoding process.

In another embodiment, an additional method may be employed where the pixels of the person in the real environment are blended into the virtual environment. For example, if a value of 0.5 was used for the refined depth mask, using the same RGBA color values of the real environment pixel and virtual environment pixel in the previous example (the virtual environment pixel RGBA is (0.8, 0.4, 0.2, 1.0) and the real environment pixel RGBA is (0.2, 0.3, 0.4, 1.0)), the output color value would be (0.5, 0.35, 0.3, 1.0), which would create a more blended image mask. Colors on the edges would be a mix between the colors contributed from both virtual environment pixel RGBA and real environment pixel RGBA.

In other embodiments, other forms of interpolation can be employed, such as Hermite interpolation, nearest neighbor, Gaussian, bi-linear, trilinear, or cubic convolution.

In other embodiments, the masking calculation might occur on additional types of shaders, such as vertex, compute, or geometry shaders or other types of shaders that can handle per-pixel calculations.

In the exemplary embodiment, the final color value is returned using additive blending. Other forms of blending such as subtractive (looks at the color information in each channel and subtracts the blend color from the base color), division (looks at the color information in each channel and divides the blend color from the base color), or multiplication (Looks at the color information in each channel and multiplies the base color by the blend color) can be employed.

With respect to the exemplary occlusion and compositing processes, these processes may occur on any digital processor, including mobile phones, desktop computers, or a remote server. This processes may occur using textures from a local recording device, video that is streamed, or pre-recorded video as input. While both processes are generally performed on the same device, either step could be performed on a server for it to serve as input for the remainder of the system that is performed on the client. For example, the occlusion determination process can occur on server that sends refined depth mask to the mobile device client, which handles the mask compositing. Alternatively, the occlusion determination can occur on the mobile device client that sends the refined depth mask to the server which performs the mask compositing. In that case, the final composite image display may be streamed from this server location for viewing on a mobile device display. If these processes are performed on a server, the connection to the server may exist as a client-server or peer-to-peer relationship.

It should also be noted that the 3D virtual environments may not need to be rendered by a particular 3D engine, but generally will be rendered using a real-time game engine. The 3D file data may be streamed to the device performing the process. Or a 2D video frame capture of the 3D scene rendered on the server may be streamed to the device performing the occlusion and masking process.

In the exemplary embodiment, the exemplary occlusion and compositing processes occur on the GPU. GPU-based implementations may be performed in frameworks such as DirectX, OpenGL. Metal, and in graphics programming languages such as GLSL and HLSL. In another embodiment, all pixel calculations and processes may be handled on the CPU.

FIG. 8 illustrates another exemplary real environment RGBA texture showing a person standing in front of a background including a few walls and a plant in a residential location. FIG. 9A illustrates an exemplary composite frame superimposing the occluded real environment of FIG. 8 consisting of the person on a mountainous virtual environment. FIG. 9B illustrates an exemplary composite frame superimposing the person of FIG. 8 on another exemplary virtual environment.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module.” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages. The program code may execute entirely on the users device, partly on the user's device, as a stand-alone software package, partly on the user's device and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present invention has been particularly shown and described with reference to certain exemplary embodiments, it will be understood by one skilled in the art that various changes in detail may be effected therein without departing from the spirit and scope of the invention that can be supported by the written description and drawings. Further, where exemplary embodiments are described with reference to a certain number of elements, it will be understood that the exemplary embodiments can be practiced utilizing either less than or more than the certain number of elements.

1-10. (canceled)

11. A method for providing augmented virtuality comprising:
capturing a real environment frame of a real environment with a real camera, wherein the real environment comprises a human and a real environment background,
rendering a real environment two-dimensional array of red, green, blue, and alpha channel transparency (RGBA) values for the real environment frame, wherein the value of each pixel in the real environment two-dimensional RGBA array comprises an RGBA value;
rendering a real environment two-dimensional depth array for the real environment frame, wherein the value of each pixel in the real environment two-dimensional depth array comprises a depth value from the real camera;
rendering a real environment two-dimensional stencil array for the real environment frame, wherein the value of each pixel in the real environment two-dimensional stencil array has a first stencil value to indicate that the pixel is associated with the human or a second stencil value to indicate that the pixel is associated with the real environment background;
capturing a virtual environment frame of a virtual environment with a virtual camera;
rendering a virtual environment two-dimensional array of red, green, blue, and alpha channel transparency (RGBA) values for the virtual environment frame, wherein the value of each pixel in the virtual environment two-dimensional RGBA array comprises an RGBA value;
rendering a virtual environment two-dimensional depth array for the virtual environment frame, wherein the value of each pixel in the virtual environment two-dimensional depth array comprises a depth value from the virtual camera;
rendering an occlusion depth array by comparing, on a pixel-by-pixel basis, the real environment two-dimensional depth array for the real environment frame and the virtual environment two-dimensional depth array for the virtual environment frame, wherein the value of each pixel in the occlusion depth array has a first occlusion value to indicate that the corresponding pixel in the virtual environment two-dimensional depth array is farther from the virtual camera than the corresponding pixel in the real environment two-dimensional depth array is from the real camera or a second occlusion value to indicate that the corresponding pixel in the virtual environment two-dimensional depth array is closer to the virtual camera than the corresponding pixel in the real environment two-dimensional depth array is to the real camera;
rendering a refined depth mask array by comparing, on a pixel-by-pixel basis, the real environment two-dimensional stencil array for the real environment frame and the occlusion depth array, wherein the value of each pixel in the refined depth mask array has a first refined depth value to indicate that the corresponding pixel in the real environment two-dimensional stencil array is associated with the human and that the corresponding pixel in the occlusion depth array has the first occlusion value or a second refined depth value to indicate that the corresponding pixel in the real environment two-dimensional stencil array is associated with the real background or that the corresponding pixel in the occlusion depth array has the second occlusion value; and
forming a composite frame on a pixel-by-pixel basis by superimposing the real environment two-dimensional RGBA array on the virtual environment two-dimensional RGBA array based on the refined depth mask array, wherein the RBGA value for each pixel in the composite frame corresponding to a pixel in the refined depth mask array that has the first refined depth value is taken from the corresponding pixel in the real environment two-dimensional RGBA array and wherein the RGBA value for each pixel in the composite frame corresponding to a pixel in the refined depth mask array that has the second refined depth value is taken from the corresponding pixel in the virtual environment two-dimensional RGBA array, and wherein the RBGA value for each pixel in the composite frame corresponding to a pixel in the refined depth mask array that has the first refined depth value on an edge of the human is taken from a blend of the RGBA values of the corresponding pixel in the real environment two-dimensional RGBA array and the corresponding pixel in the virtual environment two-dimensional RGBA array.

12. A method for providing augmented virtuality comprising:
capturing a real environment frame of a real environment with a real camera, wherein the real environment comprises a human and a real environment background,
rendering a real environment two-dimensional array of red, green, blue, and alpha channel transparency (RGBA) values for the real environment frame, wherein the value of each pixel in the real environment two-dimensional RGBA array comprises an RGBA value;
rendering a real environment two-dimensional depth array for the real environment frame, wherein the value of each pixel in the real environment two-dimensional depth array comprises a depth value from the real camera;
rendering a real environment two-dimensional stencil array for the real environment frame, wherein the value of each pixel in the real environment two-dimensional stencil array has a first stencil value to indicate that the pixel is associated with the human or a second stencil value to indicate that the pixel is associated with the real environment background;
capturing a virtual environment frame of a virtual environment with a virtual camera using a real-time game engine;
rendering a virtual environment two-dimensional array of red, green, blue, and alpha channel transparency (RGBA) values for the virtual environment frame, wherein the value of each pixel in the virtual environment two-dimensional RGBA array comprises an RGBA value;
rendering a virtual environment two-dimensional depth array for the virtual environment frame, wherein the value of each pixel in the virtual environment two-dimensional depth array comprises a depth value from the virtual camera;
rendering an occlusion depth array by comparing, on a pixel-by-pixel basis, the real environment two-dimensional depth array for the real environment frame and the virtual environment two-dimensional depth array for the virtual environment frame, wherein the value of each pixel in the occlusion depth array has a first occlusion value to indicate that the corresponding pixel in the virtual environment two-dimensional depth array is farther from the virtual camera than the corresponding pixel in the real environment two-dimensional depth array is from the real camera or a second occlusion value to indicate that the corresponding pixel in the virtual environment two-dimensional depth array is closer to the virtual camera than the corresponding pixel in the real environment two-dimensional depth array is to the real camera;
rendering a refined depth mask array by comparing, on a pixel-by-pixel basis, the real environment two-dimensional stencil array for the real environment frame and the occlusion depth array, wherein the value of each pixel in the refined depth mask array has a first refined depth value to indicate that the corresponding pixel in the real environment two-dimensional stencil array is associated with the human and that the corresponding pixel in the occlusion depth array has the first occlusion value or a second refined depth value to indicate that the corresponding pixel in the real environment two-dimensional stencil array is associated with the real background or that the corresponding pixel in the occlusion depth array has the second occlusion value; and
forming a composite frame on a pixel-by-pixel basis by superimposing the real environment two-dimensional RGBA array on the virtual environment two-dimensional RGBA array based on the refined depth mask array, wherein the RBGA value for each pixel in the composite frame corresponding to a pixel in the refined depth mask array that has the first refined depth value is taken from the corresponding pixel in the real environment two-dimensional RGBA array and wherein the RGBA value for each pixel in the composite frame corresponding to a pixel in the refined depth mask array that has the second refined depth value is taken from the corresponding pixel in the virtual environment two-dimensional RGBA array.

13. A method for providing augmented virtuality comprising:
capturing a real environment frame of a real environment with a real camera, wherein the real environment comprises a human and a real environment background,
rendering a real environment two-dimensional array of red, green, blue, and alpha channel transparency (RGBA) values for the real environment frame, wherein the value of each pixel in the real environment two-dimensional RGBA array comprises an RGBA value;
rendering a real environment two-dimensional depth array for the real environment frame, wherein the value of each pixel in the real environment two-dimensional depth array comprises a depth value from the real camera;
rendering a real environment two-dimensional stencil array for the real environment frame, wherein the value of each pixel in the real environment two-dimensional stencil array has a first stencil value to indicate that the pixel is associated with the human or a second stencil value to indicate that the pixel is associated with the real environment background;
capturing a virtual environment frame of a virtual environment with a virtual camera;
rendering a virtual environment two-dimensional array of red, green, blue, and alpha channel transparency (RGBA) values for the virtual environment frame, wherein the value of each pixel in the virtual environment two-dimensional RGBA array comprises an RGBA value;
rendering a virtual environment two-dimensional depth array for the virtual environment frame, wherein the value of each pixel in the virtual environment two-dimensional depth array comprises a depth value from the virtual camera;
rendering an occlusion depth array by comparing, on a pixel-by-pixel basis, the real environment two-dimensional depth array for the real environment frame and the virtual environment two-dimensional depth array for the virtual environment frame, wherein the value of each pixel in the occlusion depth array has a first occlusion value to indicate that the corresponding pixel in the virtual environment two-dimensional depth array is farther from the virtual camera than the corresponding pixel in the real environment two-dimensional depth array is from the real camera or a second occlusion value to indicate that the corresponding pixel in the virtual environment two-dimensional depth array is closer to the virtual camera than the corresponding pixel in the real environment two-dimensional depth array is to the real camera;
rendering a refined depth mask array by comparing, on a pixel-by-pixel basis, the real environment two-dimensional stencil array for the real environment frame and the occlusion depth array, wherein the value of each pixel in the refined depth mask array has a first refined depth value to indicate that the corresponding pixel in the real environment two-dimensional stencil array is associated with the human and that the corresponding pixel in the occlusion depth array has the first occlusion value or a second refined depth value to indicate that the corresponding pixel in the real environment two-dimensional stencil array is associated with the real background or that the corresponding pixel in the occlusion depth array has the second occlusion value; and
forming a composite frame on a pixel-by-pixel basis by superimposing the real environment two-dimensional RGBA array on the virtual environment two-dimensional RGBA array based on the refined depth mask array, wherein the RBGA value for each pixel in the composite frame corresponding to a pixel in the refined depth mask array that has the first refined depth value is taken from the corresponding pixel in the real environment two-dimensional RGBA array and wherein the RGBA value for each pixel in the composite frame corresponding to a pixel in the refined depth mask array that has the second refined depth value is taken from the corresponding pixel in the virtual environment two-dimensional RGBA array,
wherein all of the steps are performed on a mobile device, and
wherein the virtual environment frame is transmitted from a remote server to the mobile device.

14. A method for providing augmented virtuality comprising:
capturing a real environment frame of a real environment with a real camera, wherein the real environment comprises a human and a real environment background,
rendering a real environment two-dimensional array of red, green, blue, and alpha channel transparency (RGBA) values for the real environment frame, wherein the value of each pixel in the real environment two-dimensional RGBA array comprises an RGBA value;
rendering a real environment two-dimensional depth array for the real environment frame, wherein the value of each pixel in the real environment two-dimensional depth array comprises a depth value from the real camera;
rendering a real environment two-dimensional stencil array for the real environment frame, wherein the value of each pixel in the real environment two-dimensional stencil array has a first stencil value to indicate that the pixel is associated with the human or a second stencil value to indicate that the pixel is associated with the real environment background;
capturing a virtual environment frame of a virtual environment with a virtual camera;
rendering a virtual environment two-dimensional array of red, green, blue, and alpha channel transparency (RGBA) values for the virtual environment frame, wherein the value of each pixel in the virtual environment two-dimensional RGBA array comprises an RGBA value;
rendering a virtual environment two-dimensional depth array for the virtual environment frame, wherein the value of each pixel in the virtual environment two-dimensional depth array comprises a depth value from the virtual camera;
rendering an occlusion depth array by comparing, on a pixel-by-pixel basis, the real environment two-dimensional depth array for the real environment frame and the virtual environment two-dimensional depth array for the virtual environment frame, wherein the value of each pixel in the occlusion depth array has a first occlusion value to indicate that the corresponding pixel in the virtual environment two-dimensional depth array is farther from the virtual camera than the corresponding pixel in the real environment two-dimensional depth array is from the real camera or a second occlusion value to indicate that the corresponding pixel in the virtual environment two-dimensional depth array is closer to the virtual camera than the corresponding pixel in the real environment two-dimensional depth array is to the real camera;
rendering a refined depth mask array by comparing, on a pixel-by-pixel basis, the real environment two-dimensional stencil array for the real environment frame and the occlusion depth array, wherein the value of each pixel in the refined depth mask array has a first refined depth value to indicate that the corresponding pixel in the real environment two-dimensional stencil array is associated with the human and that the corresponding pixel in the occlusion depth array has the first occlusion value or a second refined depth value to indicate that the corresponding pixel in the real environment two-dimensional stencil array is associated with the real background or that the corresponding pixel in the occlusion depth array has the second occlusion value;
performing edge detection on the refined depth mask array; and
forming a composite frame on a pixel-by-pixel basis by superimposing the real environment two-dimensional RGBA array on the virtual environment two-dimensional RGBA array based on the refined depth mask array, wherein the RBGA value for each pixel in the composite frame corresponding to a pixel in the refined depth mask array that has the first refined depth value is taken from the corresponding pixel in the real environment two-dimensional RGBA array and wherein the RGBA value for each pixel in the composite frame corresponding to a pixel in the refined depth mask array that has the second refined depth value is taken from the corresponding pixel in the virtual environment two-dimensional RGBA array

15-30. (canceled)

31. The method of claim 11, wherein the step of capturing a real environment frame of a real environment with a real camera, wherein the real environment comprises a human and a real environment background is performed on a mobile device and the remaining steps are performed on a remote server.

32. The method of claim 11, further comprising the step of performing localization to match the real environment with the virtual environment.

33. The method of claim 11, further comprising the steps of:
before the step of forming a composite frame,
determining a luminosity coefficient for the virtual environment frame; and
applying the luminosity coefficient to the RGBA values of the real environment two-dimensional RGBA array for the real environment frame.

34. The method of claim 11, further comprising the steps of:
displaying the composite frame; and
storing the composite frame.

35. The method of claim 12, wherein the step of capturing a real environment frame of a real environment with a real camera, wherein the real environment comprises a human and a real environment background is performed on a mobile device and the remaining steps are performed on a remote server.

36. The method of claim 12, further comprising the step of performing localization to match the real environment with the virtual environment.

37. The method of claim 12, further comprising the steps of:
before the step of forming a composite frame,
determining a luminosity coefficient for the virtual environment frame; and
applying the luminosity coefficient to the RGBA values of the real environment two-dimensional RGBA array for the real environment frame.

38. The method of claim 12, further comprising the steps of:
displaying the composite frame; and
storing the composite frame.

39. The method of claim 13, wherein the step of capturing a real environment frame of a real environment with a real camera, wherein the real environment comprises a human and a real environment background is performed on a mobile device and the remaining steps are performed on a remote server.

40. The method of claim 13, further comprising the step of performing localization to match the real environment with the virtual environment.

41. The method of claim 13, further comprising the steps of:
before the step of forming a composite frame,
determining a luminosity coefficient for the virtual environment frame; and
applying the luminosity coefficient to the RGBA values of the real environment two-dimensional RGBA array for the real environment frame.

42. The method of claim 13, further comprising the steps of:
displaying the composite frame; and
storing the composite frame.

43. The method of claim 14, wherein the step of capturing a real environment frame of a real environment with a real camera, wherein the real environment comprises a human and a real environment background is performed on a mobile device and the remaining steps are performed on a remote server.

44. The method of claim 14, further comprising the step of performing localization to match the real environment with the virtual environment.

45. The method of claim 14, further comprising the steps of:
before the step of forming a composite frame,
determining a luminosity coefficient for the virtual environment frame; and
applying the luminosity coefficient to the RGBA values of the real environment two-dimensional RGBA array for the real environment frame.

46. The method of claim 14, further comprising the steps of:
displaying the composite frame; and
storing the composite frame.
